(19) United States
(12) Patent Application Publication
(10) Pub. No.: US 2022/0245439 A1
(43) Pub. Date: Aug. 4, 2022

(54) FAULT CRITICALITY ASSESSMENT USING GRAPH CONVOLUTIONAL NETWORKS

(71) Applicant: Duke University, Durham, NC (US)

(72) Inventors: Krishnendu CHAKRABARTY, Durham, NC (US); Arjun CHAUDHURI, Durham, NC (US); Jonti TALUKDAR, Durham, NC (US)

(21) Appl. No.: 17/162,601

(22) Filed: Jan. 29, 2021

(51) Int. Cl. G06N 3/08; G06F 7/06; G06N 3/04; G06F 16/901

(52) U.S. Cl. CPC G06N 3/08; G06F 16/9024; G06N 3/04; G06F 7/06

(57) ABSTRACT

A method of fault criticality assessment using a k-tier graph convolution network (GCN) framework, where k≥2, includes generating a graph from a netlist of a processing element implementing a target hardware architecture having an applied domain-specific use-case, wherein a logic gate is represented in the graph as a node and a signal path between two logic gates is represented in the netlist-graph as an edge; evaluating functional criticality of unlabeled nodes of the graph using a trained first GCN, and evaluating nodes classified as benign by the trained first GCN using a trained second GCN to identify misclassified nodes.

### BACKGROUND

Advances in deep neural networks (DNNs) are driving the demand for domain-specific accelerators, including for data-intensive applications such as image classification and segmentation, voice recognition and natural language processing. The ubiquitous application of DNNs has led to a rise in demand for custom artificial intelligence (AI) accelerators. Many such use-cases, including autonomous driving, require high reliability. Built-in self-test (BIST) can be used for enabling power-on self-test in order to detect in-field failures. However, DNN inferencing applications such as image classification are inherently fault-tolerant with respect to structural faults; it has been shown that many faults are not functionally critical, i.e., they do not lead to any significant error in inferencing. As a result, conventional pseudo-random pattern generation for targeting all faults with BIST is an “over-kill”. Therefore, it can be desirable to identify which nodes are critical for in-field testing to reduce overhead.

Functional fault testing is commonly performed during design verification of a circuit to determine how resistant a circuit architecture is to errors manifesting from manufacturing defects, aging, wear-out, and parametric variations in the circuit. Each node can be tested by manually injecting a fault to determine whether or not that node is critical—in other words, whether it changes a terminal output (i.e., an output for the circuit architecture as a whole) for one or more terminal inputs (i.e., an input for the circuit architecture as a whole). Indeed, the functional criticality of a fault is determined by the severity of its impact on functional performance. If the node is determined to be critical, it can often degrade circuit performance or, in certain cases, eliminate functionality. Fault simulation of an entire neural network hardware architecture to determine the critical nodes is computationally expensive—taking days, months, years, or longer—due to large models and input data size. Therefore, it is desirable to identify mechanisms to reduce the time and computation expense of evaluating fault criticality while maintaining accuracy.

### BRIEF SUMMARY

Fault criticality assessment using graph convolutional networks is described. Techniques and systems are provided that can predict criticality of faults without requiring simulation of an entire circuit.

A method of fault criticality assessment includes generating a graph from a netlist, wherein a logic gate is represented in the graph as a node and a signal path between two logic gates is represented in the netlist-graph as an edge; evaluating functional criticality of unlabeled nodes of the graph using a trained first graph convolution network (GCN), and evaluating nodes classified as benign by the trained first GCN using a trained second GCN to identify misclassified nodes. The graph being evaluating using the trained first and second GCNs is an undirected netlist-graph. Nodes of the graph classified as critical by the trained first GCN and the trained second GCN are labeled as critical nodes and nodes not labeled as critical nodes after completing all evaluations are labeled as benign. In some cases, one or more additional trained GCNs can be included, as part of a k-tier approach to further identify nodes misclassified as benign.

A method of training a system for evaluating fault criticality includes converting a netlist of a target hardware architecture having an applied domain-specific use-case to a netlist-graph, wherein a logic gate is represented in the netlist-graph as a node and a signal path between two logic gates is represented in the netlist-graph as an edge; labeling a first set of nodes of the netlist-graph, each node of the first set of nodes being labeled with a label indicating functional criticality for that node; and training a k-tier graph convolutional network (GCN), where k≥2, the k-tier GCN learning from the labels of the first set of nodes to predict labels of unlabeled nodes of the netlist-graph.

In some cases, the training of the GCNs for evaluating a processing element can be carried out based on a different processing unit (and corresponding netlist) than the processing element being evaluated for fault criticality (and corresponding netlist used to generate the graph).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a representational diagram of a process flow for fault criticality assessment for use in generating fault testing schemes for an application target.

FIG. 2 illustrates an example system for fault criticality assessment.

FIGS. 3A and 3B illustrate a node sampling method for selecting nodes of a netlist-graph for ground-truth collection.

FIG. 4 illustrates a training process for a 2-tier GCN framework.

FIG. 5 illustrates a training process for a k-tier GCN framework

FIG. 6 illustrates an example system flow for a system for evaluating fault criticality.

FIG. 7 illustrates a data compression method to achieve fault-free data compression for use in a system to evaluate fault criticality.

### DETAILED DESCRIPTION

Fault criticality assessment using graph convolutional networks is described. Techniques and systems are provided that can predict criticality of faults without requiring simulation of an entire circuit. A scalable K-tier GCN framework is provided, which can reduce the number of misclassifications when evaluating the functional criticality of faults in a processing element.

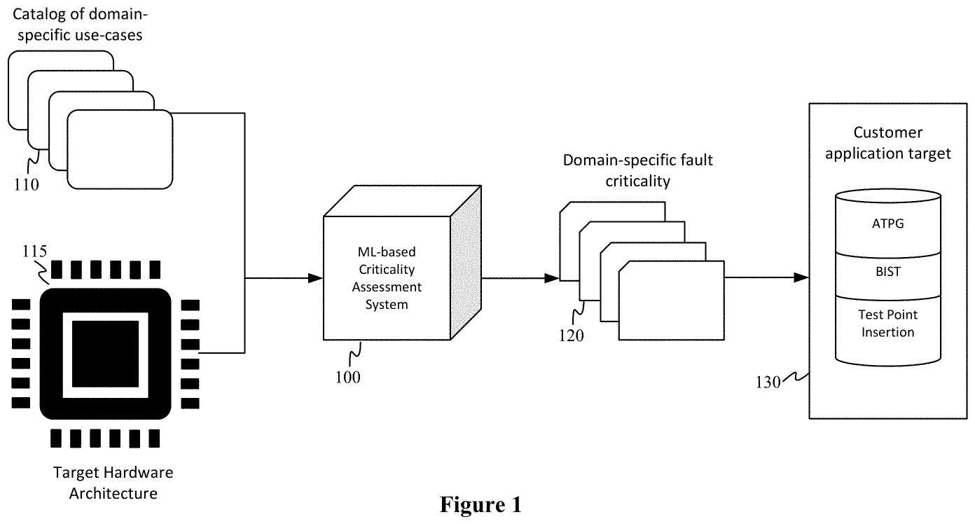

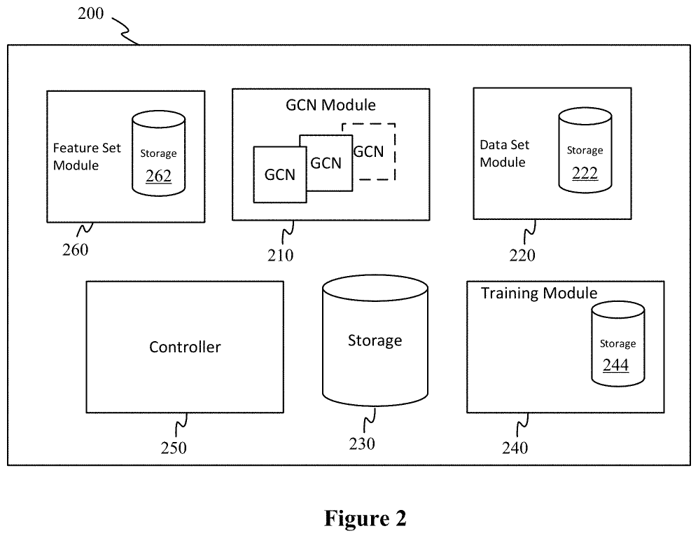

FIG. 1 illustrates a representational diagram of a process flow for evaluating fault criticality for use in generating fault testing schemes for an application target. Referring to FIG. 1, a machine-learning-based criticality assessment system 100, which may be embodied such as described with respect to system 200 of FIG. 2, can take in a domain specific use case 110 and a target hardware architecture 115 to generate information of domain-specific fault critically 120. It should be understood that a structural fault is considered functionally critical if the structural fault leads to functional failure. For example, a functional failure can be evaluated in terms of the fault's impact on inferencing accuracy (for the inferencing use-case). A fault can be deemed to be benign if the fault does not affect the inferencing accuracy for this illustrative use-case. An accuracy threshold used for classifying faults as being benign or critical can be predetermined based on the accuracy requirement and safety criticality of the use-case application. For example, if the use-case application is for autonomous vehicles, a higher accuracy may be required due to the important safety considerations. Accordingly, in addition to informing potential thresholds for benign vs. critical, the domain-specific fault criticality 120 can be applied to a customer application target 130 for specific testing measures.

The domain-specific use-case 110 can be selected from among a catalog of pre-existing domain-specific use-cases known by the machine-learning-based criticality assessment system 100 and selected by a user or provided externally. The domain-specific use-case can include any deep learning application including those used for training and inferencing. Examples include deep neural networks for image classification and segmentation (with applications to autonomous driving, manufacturing automation, and medical diagnostics as some examples), regression, voice recognition, and natural language processing. The domain-specific use-case 110 can describe how the target hardware architecture 115 will be deployed or implemented and can be used to inform the domain-specific fault criticality 120. The target hardware architecture 115 can include any computing architecture. The target hardware architecture 115 can be, for example, a systolic array of processing units (e.g., for an AI accelerator).

The circuit to be tested for fault criticality is a target hardware architecture having an applied domain-specific use-case (also referred to as a target hardware architecture with a specific neural network mapping). In some cases, the target hardware architecture having the applied domain-specific use-case can be received by the machine-learning-based criticality assessment system 100 as a representation, for example as a netlist. In some cases, fault data (simulated or actual) of the target hardware architecture having the applied domain-specific use-case is received by the machine-learning-based criticality assessment system 100. The domain-specific use-case 110 applied on the target hardware architecture 115 can be, for example, a specified machine learning system.

In some cases, the machine-learning-based criticality assessment system 100 receives information of a new circuit to be tested before being deployed. In some cases, the machine-learning-based criticality assessment system 100 receives information of a circuit already in operation that is being tested to ensure continued functionality. Indeed, it is possible to train and use the described system 100 for predicting critical nodes of a circuit under the influence of aging (i.e., over time as the circuit structures may degrade). For example, the target hardware architecture can include structural faults due to aging and the faults can be reflected in the node definitions used to both train and evaluate the circuit. The system 100 can further predict critical nodes for faults remaining due to test escape during manufacturing testing (coverage gaps), soft errors (e.g., single-event upset), and unexplained intermittent faults.

The machine-learning-based criticality assessment system 100 can perform operations such as described herein to generate the information of domain-specific fault criticality 120. The information of domain-specific fault criticality 120 can include a dataset of predicted critical nodes.

The one or more customer application targets 130 can be specific testing methodologies for fault testing implementation on the target hardware architecture 115 having the applied domain-specific use-case 110. The described techniques can be useful in creating testing methodologies to determine if a particular instance of the circuit architecture can be used in a certain application, especially in the context of circuit architectures for neural networks. Examples of possible customer application targets 130 include automatic test pattern generation (ATPG), BIST, and test point insertion.

By identifying the critical nodes, the testing methodologies for fault testing can be applied to those nodes identified by the machine-learning-based criticality assessment system 100. By determining where critical nodes exist with further knowledge of what terminal outputs are necessary, a testing methodology can be created to ensure that the particular instance of the circuit architecture can be used for that certain application as well as the extent that testing must be performed (or extent of infrastructure on a chip is needed to be added such as for BIST). Testing can be useful both before deployment and after deployment to ensure continued functionality.

Advantageously, fewer computational resources (and corresponding time and/or chip area) are required to carry out fault testing.

FIG. 2 illustrates an example system for fault criticality assessment. A machine learning (ML) system 200 for evaluating fault criticality can include a graph convolutional network (GCN) module 210. The ML system 200 can further include a data set module 220 with data set resource 222, storage resource 230, a training module 240, a controller 250, and a feature set module 260 with feature set resource 262.

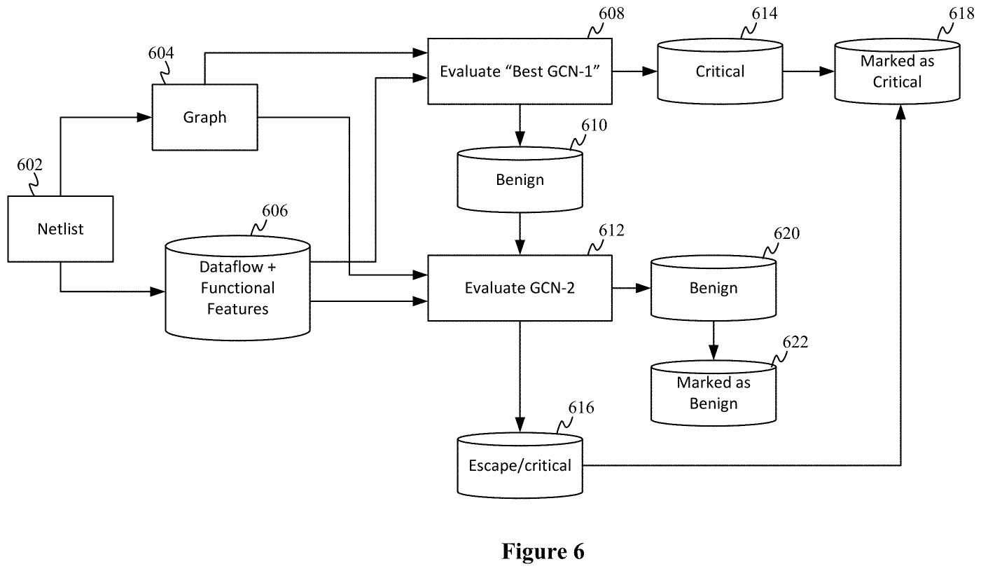

The GCN module 210 may be implemented in the form of instructions and models stored on a storage resource, such as storage resource 230, that are executed and applied by one or more hardware processors, such as embodied by controller 250, to provide two or more GCNs, supporting a scalable K-tier GCN-based framework. In some cases, the GCN module 210 has its own dedicated hardware processor(s). In some cases, the GCN module is entirely implemented in hardware. In some cases, the GCN module 210 can be used to perform the operations described with respect to FIG. 6.

A GCN is a machine learning model based on semi-supervised learning; a GCN leverages the topology of a graph for classification of nodes in the graph. That is, the gate-level netlist of a processing element can be represented as a directed graph G, where the nodes represent gates and edges represent interconnections. If both s-a-0 (stuck at 0) and s-a-1 (stuck at 1) faults at the node output are functionally benign, the node is labeled as functionally benign; otherwise, the node is labeled as critical. The forward-propagation rule in GCN uses feature information of a node as well as its neighboring nodes to justify or evaluate the node's criticality. Advantageously, a GCN implements feature aggregation of neighboring nodes to classify the criticality of a node. Therefore, GCN naturally captures the intricate node embeddings in G and does not need topological features to be provided explicitly.

GCN architecture is similar to that of a feedforward fully-connected classifier.

However, convolutional layers are not needed because the features are either provided by the user or extracted during training and evaluation. For the training and evaluation of a GCN, the netlist-graph G is saved as an undirected graph with self-loops with a symmetric adjacency matrix A to allow: (i) bi-directional transfer of feature information between adjacent nodes; (ii) feature aggregation of a node and its neighbors. A feature matrix F⁽⁰⁾ contains the user-defined feature vectors of all nodes in G and has dimensions n×f; here n is the number of nodes in G and f is the number of features describing each node in G. During layer-wise forward propagation in a GCN with L layers, normalized feature aggregation in the l-th layer is expressed as: F^{(l)}=D⁻¹·A·H^{(l-1)}, where H^{(l-1)} is the output of (l−1)-th layer, D is the diagonal node-degree matrix, A is the adjacency matrix, and F^{(l)} is the aggregated feature matrix which is an input to the non-linear transformation function g(⋅). The aggregation process essentially averages the feature vectors of a node and its neighboring nodes. Each node's features are updated with the corresponding aggregated features and are transformed to lower-dimensional representations or features using g(⋅). The output H^{(l)} of the l-th layer is: H^{(l)}=g(F^{(l)}·W^{(l)}), where W^{(l)} is the weight matrix of the l-th layer. To enforce feature-dimensionality reduction, the number of columns in W^{(l)} is set to be less than the number of columns in F^{(l)}. The aggregation expression for F^{(l)} is as follows:

$${F}^{( l )} = {D}^{- \frac{1}{2}} \cdot A \cdot {D}^{- \frac{1}{2}} \cdot {H}^{( l - 1 )} . \qquad ( l )$$

The same set of weights W^{(l)} is shared by all nodes for the l-th layer of GCN. The output of the final L-th layer is: H^{(L)}=g(F^{(L)}·W^{(L)}), where W^{(L)} has two columns. Hence, the forward propagation converts the original f-dimensional feature vector of a node to a two-dimensional feature vector for binary classification of node criticality. During training, any DNN-based backpropagation algorithm can be used to tune the GCN weights for optimizing the loss function.

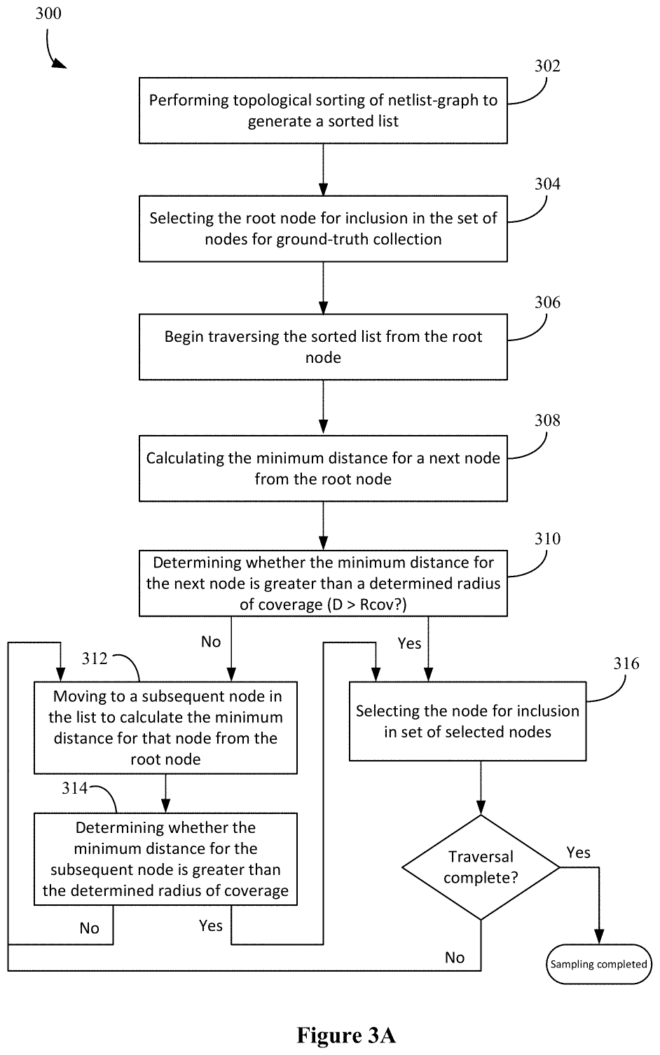

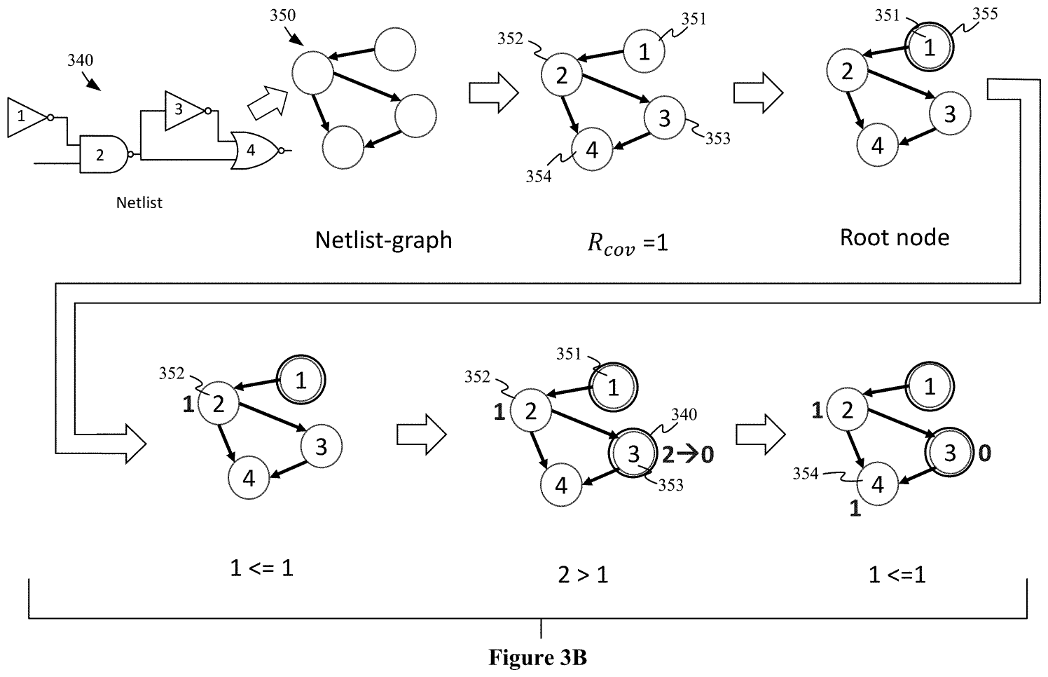

The data set module 220 can be used to generate training data sets, validation data sets, and test data sets. In some cases, where the data set module 220 includes a data set resource 222, the data sets may be stored at the data set resource 222. Training data sets and validation data sets used by the training module 240 and test data sets used by the system 200 during evaluation mode can be generated such as described with respect to FIGS. 3A and 3B.

The storage resource 230 can be implemented as a single storage device but can also be implemented across multiple storage devices or sub-systems co-located or distributed relative to each other. Storage resource 230 can include additional elements, such as a memory controller. Storage resource 230 can also include storage devices and/or sub-systems on which data and/or instructions are stored. As used herein, it should be understood that in no case does “storage device’ or “computer-readable storage media” consist of transitory media.

Datasets of benign nodes and datasets of critical nodes (including a dataset of predicted critical nodes from the GCN module 210) can be stored at the storage resource 230. The storage resource 230 can also store a netlist of the target hardware architecture. In some cases, the storage resource 230 may store feature sets of functional features and dataflow-based features used by the GCN module 210 (and by the training module 240), and training sets, validation sets, and test sets of sample nodes.

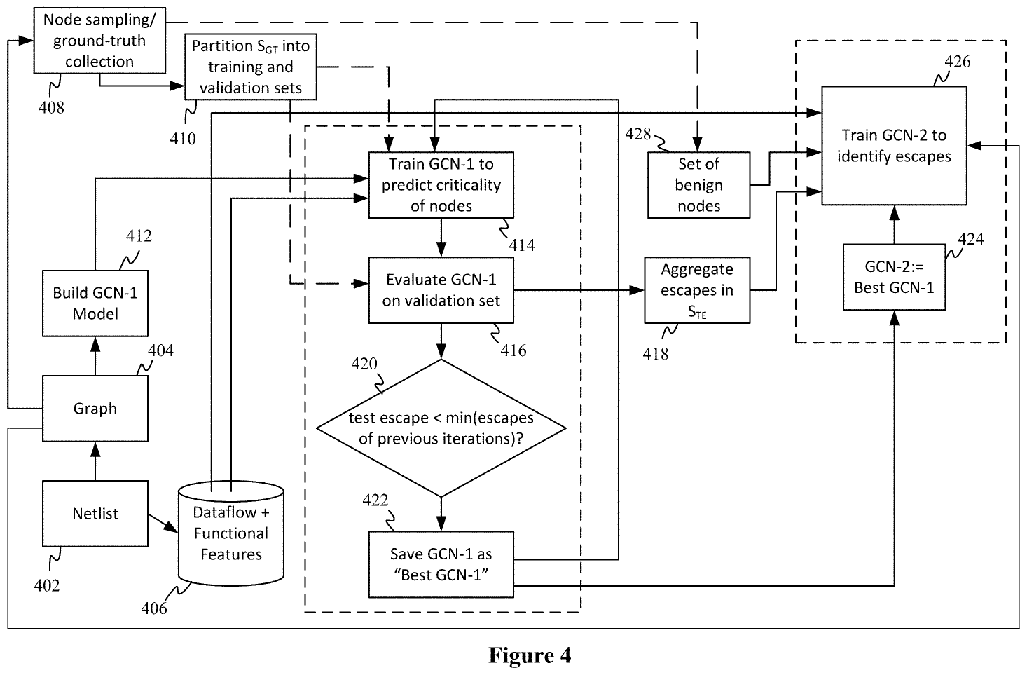

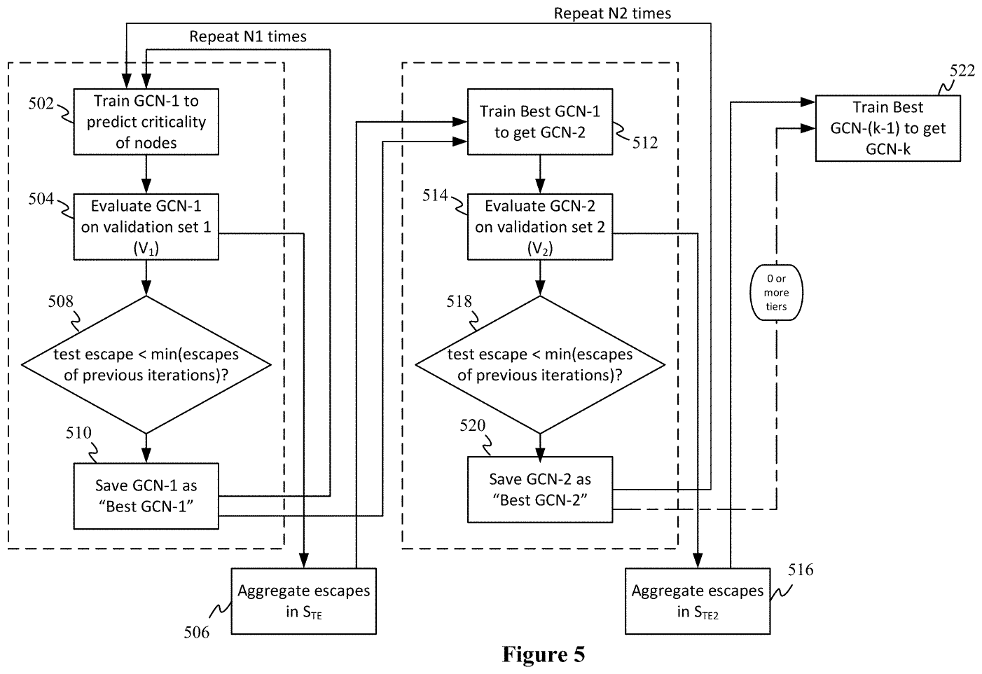

The training module 240 can be used to train the GCN module 210, for example, as described with respect to FIGS. 4 and 5.

The training module 240 can also include a training module storage 244, which can be used to store, outputs of training sessions (e.g., “Best GCN-1”), aggregate escape nodes, and other data used by the training module 240. The training module 240 may be in the form of instructions stored on a storage resource, such as storage resource 230 or training module storage 244, that are executed by one or more hardware processors, such as embodied by controller 250. In some cases, the training module 240 has a dedicated hardware processor so that the training processes can be performed independent of the controller 250. In some cases, the training module 240 is entirely implemented in hardware.

The controller 250 can be implemented within a single processing device, chip, or package but can also be distributed across multiple processing devices, chips, packages, or sub-systems that cooperate in executing program instructions. Controller 250 can include general purpose central processing units (CPUs), graphics processing units (GPUs), field programmable gate arrays (FPGAs), application specific processors, and logic devices, as well as any other type of processing device, combinations, or variations thereof.

The feature set module 260 can be used to generate the functional features and dataflow-based features for a particular target hardware architecture having the applied domain-specific use-case. Resulting features can be stored in the feature set resource 262 and retrieved by or provided to the GCN module 210.

The functional features can include number of signs, mantissa, exponent pins in a fan-out cone of a particular node, the number of primary inputs in fan-in cone of a particular node, the gate type (e.g., inverter, NAND) of the particular node (which may be one-hot encoded), and the probability of a particular node's output being 0.

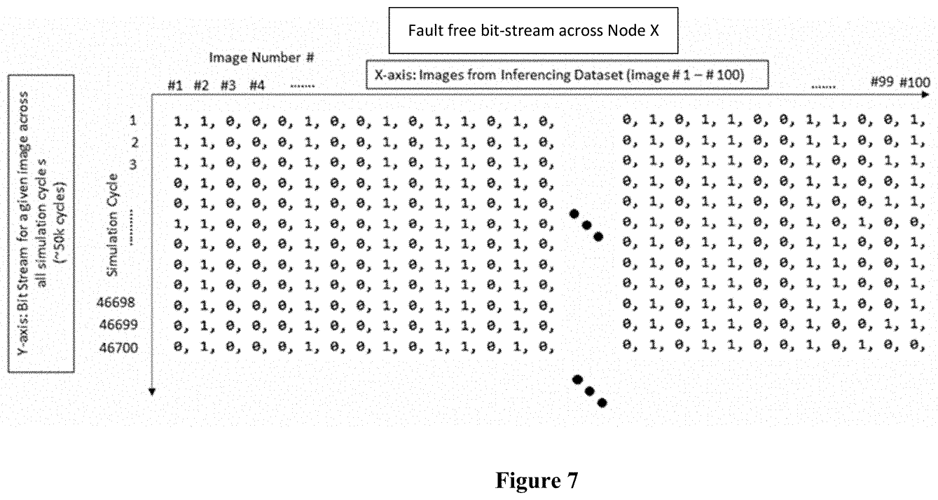

The feature set module 260 can generate the dataflow-based features by obtaining a test set of data (e.g., images with associated classes) and compressing the test set of data. Each data in the test set can include a bitstream, where each bitstream includes a certain number of bits corresponding to a total simulation cycle count for inferencing. For example, an image classifier processing element use-case, the bitstream is compressed across simulation cycles. There is no need to average the bitstreams across images in the same class in order to reduce information loss. Here, the number of dataflow-based features equals the number of images in the inferencing image set. For applications with many test images, it is possible to limit the number of dataflow-based features by applying clustering to the dataflow-based scores, using the centroid metric to represent each dataflow cluster. An example of processes that can be carried out by a feature set module 260 are described with respect to FIG. 7. In detail, dataflow-based features can be a representation of fault-free behavior. Data-streams can be applied to each node and a weighted compression across all simulation cycles can be found to determine ideal behavior at a particular node. For example, the dataflow-based features are extracted through weighted compression of the bit-stream flowing through a particular node across all simulation cycles. For example, compression is performed across all simulation cycles (in a weighted fashion) for every bitstream corresponding to a test image (note: compression is not done across the test set of images). An example is illustrated with respect to FIG. 7.

The feature set module 260 may be in the form of instructions stored on a storage resource, such as storage resource 230 or feature set storage 262, that are executed by one or more hardware processors, such as embodied by controller 250. In some cases, the feature set module 260 has a dedicated hardware processor so that the feature set generation processes can be performed independent of the controller 250. In some cases, the feature set module 260 is entirely implemented in hardware.

In some cases, the ML system 200 can include a test method module for determining a targeted testing methodology based on the domain-specific fault criticality for the domain-specific use-case applied on the target hardware architecture. The test method module can receive the dataset of predicted critical nodes (after being updated by the second machine learning module with the test escapes) and the customer application target and then determine a targeted testing methodology for the domain-specific use-case applied on the target hardware architecture using the predicted critical nodes as guides for which nodes to be tested and the customer application target for how the nodes to be tested are tested. For example, the test method module can include a storage resource that has a mapping of system test features suitable for a particular customer application target (e.g., scan chains, boundary flops, etc. for BIST) and can apply or indicate test features to a netlist at the nodes predicted to be critical. As with the other modules described with respect to ML system 200, the test method module can be implemented as instructions stored on a storage resource and executed by controller 250 or a dedicated one or more processors or implemented entirely in hardware.

For obtaining ground-truth data for the training and validation of the GCN model, functional fault simulations are carried out for specific nodes in the netlist-graph G containing V nodes. Based on the fault simulations, a node is labeled with the respective functional criticality. Node sampling can be random or via one of a variety of node sampling methods.

FIGS. 3A and 3B illustrate a node sampling method for selecting nodes of a netlist-graph for ground-truth collection. Using a sampling process based on a radius of coverage, nodes can be selected for ground-truth collection for use in training, validating, and generating a graph convolutional network for fault criticality assessment.

Referring to FIG. 3A, the node sampling method can begin with performing (302) a topological sorting of the netlist-graph to generate a sorted list. The node sampling uses a directed version of the netlist-graph (whereas the netlist-graph used for generating the graph convolutional network is an undirected netlist-graph). The root node of the netlist-graph is selected (304) for inclusion in the set of nodes for ground-truth collection and while traversing (306) the sorted list from the root node, the method includes: calculating (308) the minimum distance for a next node from the root node and determining (310) whether the minimum distance for the next node is greater than a determined radius of coverage. If the minimum distance for the next node from the root node is not greater than the determined radius of coverage, the process includes moving (312) to a subsequent node in the list to calculate the minimum distance for that node from the root node and determining (314) whether the minimum distance for that subsequent node is greater than the determined radius of coverage until the minimum distance is greater than the determined radius of coverage. If the minimum distance is greater than the determined radius of coverage, the process includes selecting (316) that node, moving to a next subsequent node in the list to calculate the minimum distance for that node from the selected node, and determining whether the minimum distance for that next subsequent node is greater than the determined radius of coverage (e.g., repeating operations 312 and 314). The process continues through the sorted list with the calculating, determining, and selecting, until all nodes have been traversed or a specified condition has been met.

FIG. 3B provides an example illustration of the node selection process. Referring to FIG. 3B, given a netlist 340, a directed netlist-graph 350 can be extracted. Here, there are four gates. A topological sorting is performed to generate a sorted list L, reflected in numbered nodes 351, 352, 353, and 354. In the illustrated example, a radius of coverage (R_{cov}) is given as R_{cov}=1, meaning that nodes that are one hop from a selected node are covered by the selected node (and the next selected node would be outside of that distance). A variable D(i) is maintained for each node i, where i∈{1, 2, 3, 4}. D(i) stores the minimum distance (in terms of #edges) of node i from a node selected for ground-truth collection. The process selects (355) the root node, the first node 351, for inclusion in the set of selected nodes and traverses the sorted list L, where for a non-root node i, calculate: D(i)=1+min {D(j)}, where j indicates parent nodes of i. If D(i)>R_{cov}, make D(i)=0 and select node i for ground-truth collection.

For example, after selecting root node 351, D(2) is calculated for the second node 352, resulting in D(2)=1. Since D(2)=1<=1 (i.e., the second node 352 is within the radius of coverage), the process traverses to the next node in the list L, the third node 353, calculates D(3)=2. Since D(3)>1, the third node 353 is selected (340) for inclusion in the set of selected nodes and D(3) is made to equal 0. The process moves to the fourth node 354, which is within the radius coverage (D(4)=1<=1), and the process ends with the first node 351 and the third node 353 in the set of selected nodes for ground-truth collection. The selection can be considered completed once traversal of the netlist-graph is completed or some other condition is specified (e.g., a certain number of nodes have been selected or a certain amount of time has passed). After selection is complete or, in some cases, while nodes are selected, ground-truth evaluation of selected nodes can be conducted (and labels applied to those selected nodes). For example, once the radius of coverage-based node sampling technique is used to select nodes (e.g., fault sites) from a graph for ground-truth collection, functional fault simulation of a node is performed on the representative dataset of an application (e.g., MNIST) to obtain the functional criticality of stuck-at faults in that node. The fault criticality is used to label the sampled node in the set of selected nodes.

Pseudocode for node sampling is provided as follows, where G is a directed netlist-graph, R_{C} is a provided radius of coverage, V refers to a node in G, and S_{GT} is the set of sample nodes for ground-truth collection.

Input: G, V, R_{C}
Output: S_{GT} / /nodes selected for ground-truth collection
Initialize D[ ] to all zeros / /1 × V array:
L_{order}[ ] ← Arrange(G);
for Vⱼ ϵ L_{order} do
| if Vⱼ is a root node then
| | S_{GT} ← S_{GT} ∪ Vⱼ;
| end
| else
| | P ← parent nodes of Vⱼ;
| | D[Vⱼ] ← 1 + min_{∀V}_{ᵢ}_{ϵP}(D[Vᵢ]);
| | if D[Vⱼ] > R_{C} then
| | | S_{GT} ← S_{GT} ∪ Vⱼ, D[Vⱼ] ← 0;
| | end
| end
end

For traversing G, the nodes in G are first arranged in a certain order using a function Arrange(G). If G contains cycles, Arrange(G) performs a breadth-first-search on G; otherwise, Arrange(G) performs

a topological sort. The nodes are visited in the arranged order (no node is visited twice) and are conditionally added to S_{GT}. If a newly visited node Vⱼ is a root node with no incoming edges, it is added to S_{GT}. If the shortest distance D (in terms of the edge count) between Vⱼ and a node in S_{GT} exceeds R_{C}, Vⱼ is added to S_{GT}. Therefore, if a node is selected for ground-truth collection, all nodes lying within the R_{C} of the selected node are not included in S_{GT}. Higher the value of R_{C}, lesser is the number of nodes sampled for S_{GT}; R_{C}≥1. The worst-case time complexity of the proposed algorithm is O(V+E), where E is the number of edges in G.

FIG. 4 illustrates a training process for a 2-tier GCN framework.

In the 2-tier GCN framework, two GCN models are applied in a cascaded manner to evaluate the functional criticality of structural faults in a processing element. Referring to FIG. 4, a process flow for training a 2-tier GCN framework includes converting a netlist 402 of a target hardware architecture having an applied domain-specific use-case to a netlist-graph 404. Dataflow and functional features 406 can be extracted from the netlist. The netlist-graph 404 is used to generate training and validation sets, for example by node sampling/ground-truth collection for nodes S_{GT} (408) and partitioning of S_{GT} into the training and validation sets (410). The labeled set of nodes S_{GT} can be randomly split into training and validation sets, where rₜᵣ is the fraction of nodes in S_{GT} that are assigned to the training set. A first GCN model (GCN-1) 412 is built from the netlist-graph 404. The adjacency matrix of the netlist-graph G (404), functional and dataflow-based features 406 of all nodes in G, and the criticality labels of the nodes in the training set (from 410) are used to train GCN-1 (414). The first tier of the 2-tier framework applies this GCN model, referred to as GCN-1, to classify the criticality of a node.

As previously mentioned, the GCN-1 model can be a feedforward fully-connected network with Nₗ layers. The input layer has I neurons, where I is the dimensionality of a node's features, and the output layer has two neurons for the binary classification. The trained GCN-1 is then evaluated (416) on the nodes in the validation set (410). During validation evaluation, the GCN-1 may misclassify some critical nodes as benign; critical faults in the misclassified nodes are considered to be test escapes. At the same time, some benign nodes may be misclassified as critical; such a scenario is considered to be a false alarm. In the described approach, the minimization of the number of test escapes is prioritized.

To reduce the number of critical nodes that are misclassified as benign, the second tier of the 2-tier framework uses a second GCN model, referred to as GCN-2, to identify critical nodes that are misclassified as benign by GCN-1. The objective of GCN-2 is to learn the feature distribution of the critical nodes misclassified by GCN-1 and distinguish them from the benign nodes.

With this objective, the weights of one of the pre-trained GCN-1 models are re-trained to generate the weights of GCN-2. In detail, the architecture of GCN-2 model is identical to that of GCN-1; GCN-2 operates on the same G and the same nodal features as those used by GCN-1. To generate GCN-2, the misclassified critical nodes obtained during the validation evaluation 416 of GCN-1 are added to a set, S_{TE} 418. In addition, the GCN-1 version producing the least number of misclassified critical nodes during validation across all the iterations is saved as the best-trained GCN-1 model. That is, a determination 420 is made as to whether the number of test escapes of a current GCN-1 iteration is less than the previously lowest number of test escapes for an iteration; and if the number of test escapes of the current GCN-1 is lower than the lowest number of test escapes of a previous iteration, the current GCN-1 is saved as the “best GCN-1”, which after all iterations is used as the GCN-2 (424).

For training GCN-2 (426), the union of misclassified critical nodes obtained after validation of GCN-1 across Nᵢₜₑᵣ iterations constitutes S_{TE}. An identical number of benign nodes are selected from S_{GT} and added to a set, S_{B} 428. The nodes in S_{TE} and S_{B} are used to train GCN-2 to distinguish between an actual benign node and a critical node that has been misclassified as benign by GCN-1. If the trained GCN-1 performs well on the validation set, the number of nodes in S_{TE} is low and may not be sufficient for training GCN-2. The amount of misclassification of critical nodes depends on how well the trained GCN-1 is able to generalize on the validation set. Therefore, the size of S_{TE} depends on the nodes in the training and validation sets, as well as on rₜᵣ which determines the amount of training data for GCN-1. To aggregate more misclassification data for training GCN-2, a selected number Nᵢₜₑᵣ (Nᵢₜₑᵣ>1) of iterations of training and validation of GCN-1 is conducted. For each iteration, the nodes in S_{GT} are randomly split into training and validation sets based on rₜᵣ.

The aggregation of misclassification data prioritizes GCN-2 training to reduce test escapes. To limit the number of false alarms, the size of S_{B} is kept higher than that of S_{TE} to introduce a partial bias in GCN-2 towards benign classification. Hence, n_{B}=┌f_{skew}·n_{TE}┐, where n_{B} and n_{TE} are sizes of S_{GT} and S_{GT}, respectively; f_{skew} is the skew factor (f_{skew}>1).

Accordingly, a method for fault criticality assessment can include converting a netlist to a netlist-graph, wherein a logic gate is represented in the netlist-graph as a node and a signal path between two logic gates is represented in the netlist-graph as an edge; labeling a first set of nodes of the netlist-graph, each node of the first set of nodes being labeled with a label indicating functional criticality for that node; and training a k-tier graph convolutional network (GCN), where k≥2, the k-tier GCN learning from the labels of the first set of nodes to predict labels of unlabeled nodes of the netlist-graph, wherein a first GCN of the k-tier GCN is trained to identify criticality of nodes and a second GCN of the k-tier GCN is trained to identify test escapes.

Indeed, training the 2-tiered GCN can include partitioning the first set of nodes into at least two training sets and a validation set; extracting dataflow features and functional features from the netlist; and for each training set of the at least two training sets: generating a first GCN for the netlist-graph; training the first GCN to predict criticality of nodes using the training set, the dataflow features, and the functional features; evaluating the first GCN using the validation set to determine a number of test escapes; store the test escapes as part of a set of test escape nodes; and after evaluating a first generated first GCN, when the number of test escapes is less than a lowest number of test escapes of a previously generated first GCN, store the first GCN as the best first GCN. Then, after completing a specified number of iterations for the first GCN, the process further includes assigning the best first GCN as a second GCN; and training the second GCN to identify the test escapes using a set of benign nodes from the first set of nodes, the set of test escape nodes, the dataflow features, and the functional features.

FIG. 5 illustrates a training process for a k-tier GCN framework.

The 2-tier GCN framework aims at reducing test escapes during the criticality evaluation of structural faults. To achieve lower test escape, a third tier (or more) can be added to the 2-tier framework for further screening of the critical nodes in G. Here, at least a third GCN model, GCN-3 (“GCN-k”), is included to identify critical nodes that are misclassified as benign by GCN-2.

The training and validation of the 3-tier framework for a processing element proceeds using the following steps:

1: Randomly divide S_{GT} into two sets, T₁ and V₂. The set T₁ is used for training and validation of GCN-1, and training of GCN-2. The set V₂ is used for validation of the trained 2-tier framework. The fractions of nodes assigned to T₁ and V₂ are

$${r}_{tr} + \frac{1 - {r}_{tr}}{2} and \frac{1 - {r}_{t r}}{2} ,$$

respectively.

2: Randomly divide T₁ into T and V₁ in the ratio

$${r}_{tr} : \frac{1 - {r}_{t r}}{2} .$$

3: The GCN-1 model is trained (502) on T and validated (504) on V₁.

4: Repeat Steps 2-3 N1 times. Test escapes are stored in S_{TE} (506) such that the misclassified critical nodes after validation on V₁ are aggregated in the set S_{TE} across N1 iterations. The best-trained version of GCN-1 is saved (according to operations 508 and 510).

5: GCN-2 is trained (512) using the misclassified data in S_{TE} and actual benign nodes selected based on f_{skew}. This step concludes the training of the 2-tier framework.

6: The 2-tier framework (best-trained GCN-1 and trained GCN-2) is validated on V₂ (514).

7: Repeat Steps 1-6 N2 times. Test escapes are stored in S_{TE2} (516) such that the misclassified critical nodes after validation on V₂ are aggregated in the set S_{TE2} across N2 iterations. The best-trained 2-tier framework, with the least number of misclassified critical nodes in V₂, is also saved (according to operations 518 and 520).

8: The GCN-3 is trained (522) using the misclassified data in S_{TE2} and actual benign nodes selected based on f skew. This step concludes the training of the 3-tier framework. The training and validation of the 3-tier framework runs for N1·N2 iterations, where each iteration comprises Ep epochs of GCN-1 training; Ep=500 was found to be sufficient for model convergence. During the criticality evaluation of unlabeled nodes, a node is considered to be functionally benign if it is classified as benign by GCN-1, GCN-2, and GCN-3. Otherwise, it is designated as functionally critical.

By following the above procedure, additional tiers can be included.

Indeed, training the k-tier GCN can include partitioning the first set of nodes into at least two training sets and at least two validation sets; extracting dataflow features and functional features from the netlist; and for each training set of the at least two training sets: generating a first GCN for the netlist-graph; training the first GCN to predict criticality of nodes using the training set, the dataflow features, and the functional features; evaluating the first GCN using the validation set to determine a number of test escapes; store the test escapes as part of a set of test escape nodes; and after evaluating a first generated first GCN, when the number of test escapes is less than a lowest number of test escapes of a previously generated first GCN, store the first GCN as the best first GCN.

After completing a specified number of iterations for the first GCN, the process can further include assigning the best first GCN as a second GCN; training the second GCN to identify the test escapes using the set of test escape nodes, the dataflow features, and the functional features; evaluating the second GCN using the second validation set to determine a second number of second test escapes; storing the second test escapes as part of a second set of test escape nodes; and after evaluating a first generated second GCN, when the second number of second test escapes is less than a lowest number of second test escapes of a previously generated second GCN, store the second GCN as the best second GCN. Then, after completing a specified number of iterations for the second GCN, the process includes assigning the best second GCN as a third GCN; and training the third GCN to identify the second test escapes using a set of benign nodes from the first set of nodes, the second set of second test escape nodes, the dataflow features, and the functional features.

FIG. 6 illustrates an example system flow for a system for evaluating fault criticality. Referring to FIG. 6, a process flow for evaluating fault criticality using a 2-tier GCN framework (note: also applicable to 3-tier and higher frameworks) includes converting a netlist 602 of a target hardware architecture having an applied domain-specific use-case to an undirected netlist-graph G 604. Dataflow and functional features 606 can be extracted from the netlist.

During evaluation (608) of the functional criticality of the unlabeled nodes in G, the adjacency matrix of G 604 and the functional and dataflow-based features 606 of all nodes in G are fed as inputs to the best-trained GCN-1 model. The nodes classified as benign 610 by GCN-1 are then evaluated (612) by the trained GCN-2 model for the potential detection of misclassified critical nodes. If a node is classified as critical 614, 616 by either GCN-1 or GCN-2, it is considered to be functionally critical 618. Otherwise, nodes classified as benign 620 are considered to be functionally benign 622.

The trained 2-tier framework is used to evaluate the fault criticality in processing elements other than the processing element for which it was trained. For a systolic array, all processing elements have identical topologies, enabling direct transferability. However, it is also possible to apply a trained GCN framework to non-identical topologies, including those with similar even if not identical topologies.

FIG. 7 illustrates a data compression method to achieve fault-free data compression for use in a system to evaluate fault criticality. This can be used, for example, in determining dataflow-based features for a target hardware architecture. In the example shown in the FIG. 7, a dataset comprising dataflow-based features includes 10 classes each with 10 test images, for a total of 100 test images (Tᵢₘ) each with corresponding bitstreams, wherein each bitstream includes a certain number of bits corresponding to a total simulation cycle count for inferencing (N_{cyc}).

A dataset comprising 100 bitstreams can be compressed using a first method of compression along all images (i.e., along Tᵢₘ) and a second method of compression along all simulation cycles (i.e., along N_{cyc}). The first method and second method can both be used to further compress the dataset.

The first method can compress all bitstreams relating to one class into a single representative bit stream. For each simulation cycle, a bit value can be found by choosing a bit value that occurs most frequently across all images belonging to the one class. The second method can compress a bitstream to a single score. If bᵢⱼ is the bit-value of the i^{th} cycle of the j^{th} bit-stream, then the score of the particular class represented by the bit-stream can be Sⱼ=Σᵢ₌₁^{N}^{_{cycle}}(bᵢⱼ×i). As such, bits at the end can be given increased weight when compared to bits in initial cycles. In the example, the dataset comprising of 100×46700 bits can be compressed to only ten.

The 2-tier GCN-based framework and the 3-tier GCN-based framework were evaluated using Deep Graph Library with a 32-bit adder, a 32-bit multiplier, and a 16-bit processing element. With the ground-truth set of 713B and 207C for the 32-bit adder, 477B and 77C for the 32-bit multiplier, and 224B and 116C for the 16-bit processing element; and the evaluation set of 251B and 125C for the 32-bit adder, 288B and 42C for the 32-bit multiplier, and 331B and 182C for the 16-bit processing element.

For the 2-tier GCN-based framework configuration for training, validation, and evaluation on PE(20,0), validation split ratio of ground-truth (R={0.6,0.75}), number of layers in GCN model (L={7,10}), number of iterations of GCN-1 training (N₁={3,4,5,6,7}), and skew ratio of #benign nodes:#escape nodes (f_{skew}={2,3,4,5}). The results are shown in Table 1 below.

TABLE 1

| | | | | | | | Faults |
|---|---|---|---|---|---|---|---|
| | | | | | Test | Catastrophic | dropped |
| | | | | | Accuracy | Test Escape | from in-field |
| Netlist | L | N₁ | f_{skew} | R | (%) | (%) | testing (%) |
| 32-bit | 7 | 4 | 2 | 0.6 | 81.2 | 1.2 | 65.6 |
| adder | | | | | | | |
| 32-bit | 7 | 5 | 2 | 0.6 | 84.4 | 0 | 87.9 |
| multiplier | | | | | | | |
| 16-bit PE | 10 | 4 | 2 | 0.6 | 78.8 | 0 | 38.6 |

For the 3-tier GCN-based framework configuration for training, validation, and evaluation on PE(20,0), validation split ratio of ground-truth (R={0.6,0.75}), number of layers in GCN model (L={7,10}), number of iterations of GCN-1 training (N₁={3,4,5,6,7}), number of iterations of GCN-2 training (N₂={3,4,5,6,7}), and skew ratio of #benign nodes:#escape nodes (f_{skew}={2,3,4,5}). The results are shown in Table 2 below.

TABLE 2

| | | | | | | | Cata- | Faults |
|---|---|---|---|---|---|---|---|---|
| | | | | | | | strophic | dropped |
| | | | | | | Test | Test | from |
| | | | | | | Accuracy | Escape | in-field |
| Netlist | L | N₁ | N₂ | f_{skew} | R | (%) | (%) | testing (%) |
| 32-bit | 10 | 4 | 4 | 3 | 0.75 | 81.9 | 0.9 | 65.6 |
| adder | | | | | | | | |
| 32-bit | 10 | 4 | 4 | 3 | 0.6 | 85.2 | 0 | 85.9 |
| multiplier | | | | | | | | |
| 16-bit PE | 10 | 5 | 5 | 5 | 0.6 | 75.6 | 0 | 26.9 |

For an evaluation of transferability of the trained 3-tier framework, the best-performing configuration of the framework (evaluated on PE(20,0) is transferred for each netlist. 50 to 100 nodes were used in the evaluation set and Δs:% reduction in the number of faults to be targeted for in-field test. The results are shown in Table 3 below.

TABLE 3

| | Netlist | | | | | | | | |
|---|---|---|---|---|---|---|---|---|---|
| | 32-bit Adder | | | 32-bit Multiplier | | | 16-bit PE | | |
| | Test | Catastrophic | | Test | Catastrophic | | Test | Catastrophic | |
| PE | Accuracy | Test Escape | Δs | Accuracy | Test Escape | Δs | Accuracy | Test Escape | Δs |
| Location | (%) | (%) | (%) | (%) | (%) | (%) | (%) | (%) | (%) |
| (45, 0) | 90 | 0 | 40.3 | 61.3 | 2.4 | 87.2 | 88.5 | 0 | 28.9 |
| (45, 8) | 88 | 0 | 37.3 | 56 | 0 | 87.1 | 63 | 0 | 29.1 |
| (25, 16) | 59 | 0 | 20.3 | 79 | 0 | 88.3 | 70 | 0 | 30.6 |
| (21, 70) | 59 | 0 | 40.8 | 70.4 | 0 | 86.7 | 55 | 0 | 29.5 |
| Diff. | 77 | 0 | | 94 | 0 | | 67 | 0 | |
| workload | | | | | | | | | |

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for fault criticality assessment, comprising:
converting a netlist of a target hardware architecture having an applied domain-specific use-case to a netlist-graph, wherein a logic gate is represented in the netlist-graph as a node and a signal path between two logic gates is represented in the netlist-graph as an edge;
labeling a first set of nodes of the netlist-graph, each node of the first set of nodes being labeled with a label indicating functional criticality for that node; and
training a k-tier graph convolutional network (GCN), where k≥2, the k-tier GCN learning from the labels of the first set of nodes to predict labels of unlabeled nodes of the netlist-graph, wherein a first GCN of the k-tier GCN is trained to identify criticality of nodes and a second GCN of the k-tier GCN is trained to identify test escapes.

2. The method of claim 1, further comprising:
evaluating functional criticality of unlabeled nodes of a graph using the k-tier GCN, wherein the graph is generated from a corresponding netlist, wherein nodes of the graph classified as critical by GCNs of the k-tier GCN are labeled as critical nodes and nodes not labeled as critical nodes after completing all evaluations are labeled as benign.

3. The method of claim 2, wherein the corresponding netlist is the netlist of the target hardware architecture having the applied domain-specific use-case, wherein the graph is an undirected netlist-graph.

4. The method of claim 1, wherein labeling the first set of nodes of the netlist-graph comprises:
selecting nodes for the first set of nodes; and
performing a ground-truth collection for each of the selected nodes.

5. The method of claim 4, wherein selecting nodes for the first set of nodes comprises randomly selected the nodes for the first set of nodes.

6. The method of claim 4, wherein selecting nodes for the first set of nodes comprises:
performing a topological sorting of the netlist-graph to generate a sorted list;
selecting a root node for the first set of nodes; and
while traversing the sorted list from the root node:
calculating a minimum distance for a next node from the root node;
determining whether the minimum distance for the next node is greater than a determined radius of coverage;
if the minimum distance for the next node from the root node is not greater than the determined radius of coverage, moving to a subsequent node in the list to calculate the minimum distance for that node from the root node and determining whether the minimum distance for that subsequent node is greater than the determined radius of coverage until the minimum distance is greater than the determined radius of coverage;
if the minimum distance is greater than the determined radius of coverage, selecting that node, moving to a next subsequent node in the list to calculate the minimum distance for that node from the selected node, and determining whether the minimum distance for that next subsequent node is greater than the determined radius of coverage; and
continuing through the sorted list with the calculating, determining, and selecting, until all nodes have been traversed or a specified condition has been met.

7. The method of claim 1, wherein training the k-tier GCN comprises:
partitioning the first set of nodes into at least two training sets and a validation set;
extracting dataflow features and functional features from the netlist; and
for each training set of the at least two training sets:
generating a first GCN for the netlist-graph;
training the first GCN to predict criticality of nodes using the training set, the dataflow features, and the functional features;
evaluating the first GCN using the validation set to determine a number of test escapes;
store the test escapes as part of a set of test escape nodes; and
after evaluating a first generated first GCN, when the number of test escapes is less than a lowest number of test escapes of a previously generated first GCN, store the first GCN as a best first GCN.

8. The method of claim 7, wherein training the k-tier GCN further comprises:
after completing a specified number of iterations for the first GCN, assigning the best first GCN as a second GCN; and
training the second GCN to identify the test escapes using a set of benign nodes from the first set of nodes, the set of test escape nodes, the dataflow features, and the functional features.

9. The method of claim 7, wherein the first set of nodes are further partitioned into a second validation set,
wherein training the k-tier GCN further comprises:
after completing a specified number of iterations for the first GCN, assigning the best first GCN as a second GCN;
training the second GCN to identify the test escapes using the set of test escape nodes, the dataflow features, and the functional features;
evaluating the second GCN using the second validation set to determine a second number of second test escapes;
storing the second test escapes as part of a second set of test escape nodes; and after evaluating a first generated second GCN, when the second number of second test escapes is less than a lowest number of second test escapes of a previously generated second GCN, store the second GCN as the best second GCN,
after completing a specified number of iterations for the second GCN, assigning the best second GCN as a third GCN; and
training the third GCN to identify the second test escapes using a set of benign nodes from the first set of nodes, the second set of second test escape nodes, the dataflow features, and the functional features.

10. A system for fault criticality assessment comprising:
a storage device; and
a graph convolutional network (GCN) module configured to:
generate a graph from a netlist of a target hardware architecture having an applied domain-specific use-case, wherein a logic gate is represented in the graph as a node and a signal path between two logic gates is represented in the graph as an edge;
evaluate functional criticality of unlabeled nodes of the graph using a trained first GCN; and
evaluate nodes classified as benign by the trained first GCN using a trained second GCN to identify misclassified nodes,
wherein nodes of the graph classified as critical by the trained first GCN and the trained second GCN are labeled as critical nodes and nodes not labeled as critical nodes after completing all evaluations are labeled as benign.

11. The system of claim 10, wherein the GCN module further comprises a trained third GCN used to evaluate nodes classified as benign by the trained second GCN.

12. The system of claim 10, further comprising:
a training module configured to:
generate a netlist-graph, wherein a logic gate is represented in the netlist-graph as a node and a signal path between two logic gates is represented in the netlist-graph as an edge;
label a first set of nodes of the netlist-graph, each node of the first set of nodes being labeled with a label indicating functional criticality for that node; and
train a k-tier GCN, including the trained first GCN and the trained second GCN, where k≥2, the k-tier GCN learning from the labels of the first set of nodes to predict labels of unlabeled nodes of the netlist-graph.

13. The system of claim 12, wherein the netlist-graph is a same graph as the graph generated from the netlist of the target hardware architecture having the applied domain-specific use-case.

14. The system of claim 12, wherein the netlist-graph is generated from a different netlist than that of the graph.
